(19) United States
(12) Patent Application Publication
(10) Pub. No.: US 2012/0278698 A1
(43) Pub. Date: Nov. 1, 2012

(54) METHOD AND SYSTEM FOR PROCESSING A WEBPAGE

(75) Inventors: JIE HU, SHANGHAI (CN); LING LUO, SHANGHAI (CN); WEI JI SHI, SHANGHAI (CN); DAN WANG, SHANGHAI (CN)

(73) Assignee: INTERNATIONAL BUSINESS MACHINES CORPORATION, ARMONK, NY (US)

(21) Appl. No.: 13/454,389

(22) Filed: Apr. 24, 2012

(30) Foreign Application Priority Data
Apr. 29, 2011 (CN) 201110110160.8

(51) Int. Cl. G06F 17/00

(52) U.S. Cl. 715/234

(57) ABSTRACT

Processing and/or rendering a web page can include acquiring a DOM content of a main window of the web page; generating, according to at least one predetermined rendered style and the DOM content of the main window, a DOM content corresponding to the at least one predetermined rendered style; and rendering the DOM content corresponding to the at least one predetermined rendered style in at least one window other than the main window.

### CROSS-REFERENCE TO RELATED APPLICATIONS

This application claims the benefit of China Application Number 201110110160.8 filed on Apr. 29, 2011, which is fully incorporated herein by reference.

### BACKGROUND

A web page application program often needs simulating different display modes in the process of development and test thereof. For example, it is wished that much software can meet the requirements of information accessibility. Information accessibility means that software can provide normal use of acquiring information for people including disabilities. Therefore, for such web page application programs, in the process of development and testing thereof, it is often needed to simulate the computer to be a mode in which users with disabilities can read and acquire information. With such specific mode, developers and testers should make sure that the programs can be operated and acquired by the disabled as completely as possible. Simulations of eyesight scenarios are included in such a series of specific modes, which will help those people who have eyesight defects such as amblyopia, color blindness, highly near-sighted and presbyopia to acquire the information comparatively completely and comprehensively. It should be made sure that in each specific display mode, the function of the web page program is complete and all the information can be acquired.

A general scheme at present is to simulate by a computer a specific display scenario according to changes in a series of environmental parameters, to run all the functions once, and to perform function verification manually to guarantee that all the readable information occurring in the process can be normally displayed in the specific display mode.

Since simulating such a kind of specific display mode generally needs configuring the whole computer environment, the configuration and switch processes are very time-consuming. Moreover, since the parameters of the whole system are changed, when it is wanted to test a plurality of specific display modes, it has to ceaselessly switch over between the scenarios, which is also very time-consuming.

Function verification in the specific display mode needs a comprehensive function test in each simulated scenario, which means that, the same complicated function test will be repeated in various simulated scenarios.

In addition, for an information integrity test in a specific display mode, testers need to memorize information that will occur in all the web pages in each step, and then switch to the specific display mode for information verification. With the increase of the complexity of the page information, only manual memory and test will easily result in test error.

### BRIEF SUMMARY

One or more embodiments disclosed within this specification relate to a web page processing technology, and more specifically, to a method and system for testing a plurality of rendered styles web page. One or more embodiments provide an improved solution capable of testing different simulated display scenarios.

According to an aspect of the invention, a method of processing a web page is provided, including: acquiring a DOM content of a main window of the web page; generating, according to at least one predetermined rendered style and the DOM content of the main window, a DOM content corresponding to the at least one predetermined rendered style; and rendering the DOM content corresponding to the at least one predetermined rendered style in at least one window other than the main window.

According to another aspect of the invention, a system for rendering a web page is provided, including: DOM content acquiring means configured to acquire a DOM content of a main window of the web page; DOM content generating means configured to generate, according to at least one predetermined rendered style and the DOM content of the main window, a DOM content corresponding to the at least one predetermined rendered style; and rendering means configured to render the DOM content corresponding to the at least one predetermined rendered style in at least one window other than the main window.

According to another aspect of the invention, a system for rendering a web page is provided including a processor configured to initiate executable operations. The executable operations can include: acquiring a Document Object Model (DOM) content of a main window of the web page; generating, according to at least one predetermined rendered style and the DOM content of the main window, a DOM content corresponding to the at least one predetermined rendered style; and rendering the DOM content corresponding to the at least one predetermined rendered style in at least one window other than the main window.

According to another aspect of the invention, a computer program product for processing a web page is provided including a computer readable storage medium having stored thereon program code that, when executed, configures a processor to perform executable operations. The executable operations can include: acquiring a Document Object Model (DOM) content of a main window of the web page; generating, according to at least one predetermined rendered style and the DOM content of the main window, a DOM content corresponding to the at least one predetermined rendered style; and rendering the DOM content corresponding to the at least one predetermined rendered style in at least one window other than the main window.

### BRIEF DESCRIPTION OF THE SEVERAL VIEWS OF THE DRAWINGS

The above and other objects, features and advantages of the embodiments of the invention will be more apparent by describing exemplary embodiments of the invention shown in the accompanying drawings with more details, in the drawings:

FIG. 1 shows a block diagram of an exemplary computer system adapted to carry out an embodiment of the invention;

FIG. 2 shows a method of processing a web page according to an embodiment of the invention;

FIG. 3 shows a method of processing a web page according to another embodiment of the invention;

FIG. 4 is a schematic diagram showing exhibiting different rendered styles of the web page by using a plurality of rendering windows according to an embodiment of the invention; and

FIG. 5 shows a system for processing a web page according to an embodiment of the invention.

### DETAILED DESCRIPTION

The invention will be described below with reference to the method and system according to the embodiments of the invention. As will be appreciated by one skilled in the art, aspects of the present invention can be embodied as a system, method or computer program product. Accordingly, aspects of the present invention can be implemented as an entire hardware, an entire software (including firmware, resident software, microcode, etc.) or a combination of software and hardware, which is generally be referred to herein as a “circuit,” “module” or “system.” Furthermore, aspects of the present invention may take the form of a computer program product embodied in one or more computer readable medium having computer usable program code embodied therein.

Any combination of one or more computer readable medium(s) may be utilized. The computer readable medium may be, for example, but not limited to, an electronic, magnetic, optical, electromagnetic, infrared, or semiconductor system, apparatus, device, or any combination thereof. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any combination thereof. In the context of this document, a computer readable storage medium may be any tangible medium that contains or stores a program for use by or in connection with an instruction execution system, apparatus, or device.

A computer readable signal medium may include a data signal with computer usable program code embodied therein, propagated in baseband or as part of a carrier wave. The propagated signal may take a number of forms, including but not limited to, an electromagnetic signal, an optical signal, or any appropriate combination of the above. The computer readable signal medium may be any computer readable medium that can send, propagate, or transmit a program for use by or in connection with an instruction execution system, apparatus, or device, other than computer readable storage medium. The program code contained on the computer readable medium may be transmitted using any appropriate medium, including but not limited to wireless, wireline, optical fiber cable, RF, etc., or any appropriate combination of the above.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the computer or other programmable data processing apparatus, create means for implementing the functions/acts specified in the blocks of the flowchart illustrations and/or block diagrams.

These computer program instructions may also be stored in a computer readable medium that can direct a computer or other programmable data processing apparatus to function in a particular manner, such that the instructions stored in the computer readable medium produce an article of manufacture including instruction means which implement the functions/acts specified in the blocks of the flowchart illustrations and/or block diagrams.

The computer program instructions may also be loaded onto a computer or other programmable data processing apparatus to cause a series of operational steps to be performed on the computer or other programmable data processing apparatus to produce a computer implemented process such that the instructions being executed on the computer or other programmable apparatus provide processes for implementing the functions/acts specified in the blocks of the flowchart illustrations and/or block diagrams.

Document Object Model (DOM) is discussed first before describing the embodiments of the invention. Document Object Model (DOM) is a standard programming interface capable of processing extensible markup language, recommended by the W3C organization. DOM defines a group of platform and language-independent interfaces, such that programs and scripts can dynamically access and modify the content, structure and style of a XML document, and render the corresponding document to be a tree structure (node tree) with elements, attributes and text. In the DOM tree, there is a root node, and all other nodes are descenders of the root node, wherein the type of the nodes may be element, text, attribute, notation or others. In the application, a DOM-based HTML/XML analyzer converts a HTML/XML document into a DOM tree and the application program operates the HTML/XML document data by operating the DOM tree. For example, by using the DOM, developers can dynamically create XML, traverse the document, add/delete/modify document content and etc.

The embodiments according to the invention will be described below with respect to the accompanying drawings. One or more embodiments can start with an inputted document object model (DOM) finally displayed in the web page, and performing unified scenario simulation for each node appearing in the web page, which can realize simultaneous exhibition of a plurality of display modes, thereby facilitating detection of information integrity by the testers. Meanwhile, by listening to node events in the document object mode (DOM), functions in various display scenarios are made consistent with each other, such that by performing the function detection in a certain scenario only once, the testers can at the same time test and validate function tests in other simulated scenarios, thereby saving a lot of time.

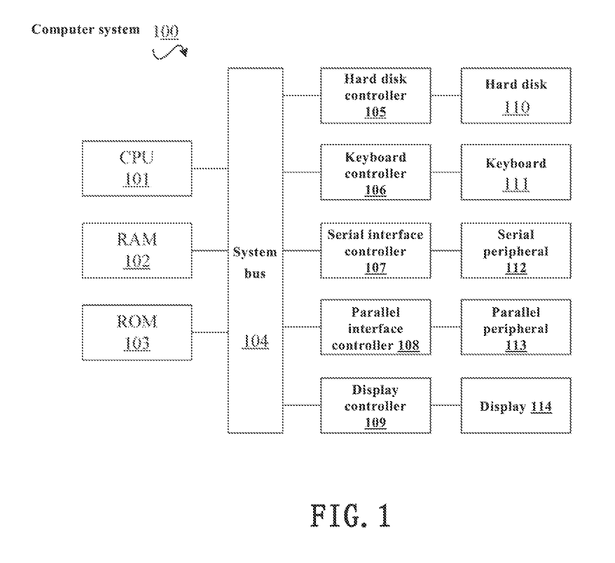

FIG. 1 shows a block diagram of an exemplary computer system 100 adapted to carry out an embodiment of the invention. As shown in FIG. 1, the computer system 100 may include: a CPU (central processing unit) 101, a RAM (random access memory) 102, a ROM (read only memory) 103, system bus 104, hard disk controller 105, keyboard controller 106, serial interface controller 107, parallel interface controller 108, display controller 109, hard disk 110, keyboard 111, serial peripheral 112, parallel peripheral 113 and display 114. Among the devices, what is coupled to the system bus 104 includes: CPU 101, RAM 102, ROM 103, hard disk controller 105, keyboard controller 106, serial controller 107, parallel controller 108 and display controller 109. The hard disk 110 is coupled to the hard disk controller 105, the keyboard 111 is coupled to the keyboard controller 106, the serial external device 112 is coupled to the serial interface controller 107, the parallel external device 113 is coupled to the parallel interface controller 108, and the display 114 is coupled to the display controller 109. It should be appreciated that, the block diagram shown in FIG. 1 is shown merely for illustration and is not intended to limit the scope of the embodiments of the invention. In some cases, some devices can be added or deleted according to specific situations.

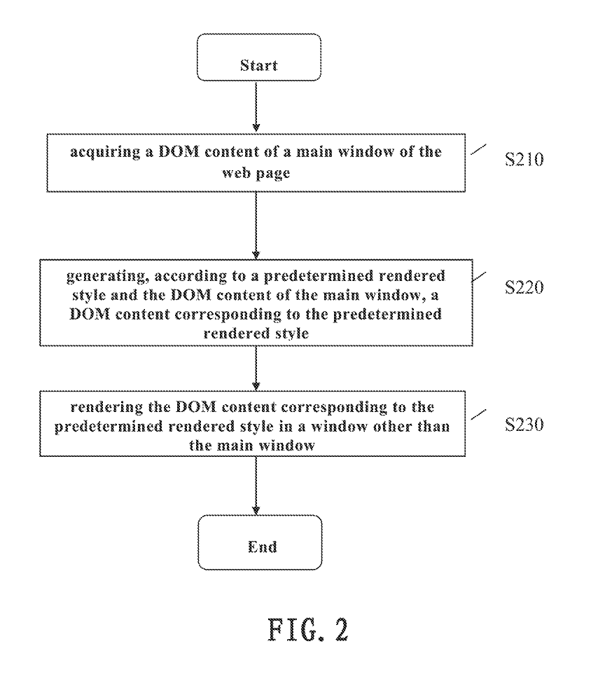

FIG. 2 shows a method of processing a web page according to an embodiment of the invention. In FIG. 2, in a step S210, a DOM content of a main window of the web page is acquired. Acquiring the DOM content of the current page from a browser is generally implemented by JavaScript from an API (application programming interface) provided by the browser, or directly obtained from an API in some plugins of Firefox, e.g., FireBug. The DOM content is a tree structure with elements, attributes and text, i.e., a DOM tree.

Next, in a step S220, according to a predetermined rendered style and the DOM content of the main window, a DOM content corresponding to the predetermined rendered style is generated. The rendered style may be preset, e.g., may include Cascading Style Sheet (CSS) styles with different configurations. According to different rendering scenarios to be tested, respective CSS configurations can be provided. In testing the target rendering scenario, by traversing all the nodes in the DOM by JavaScript, those CSS meeting rules can be applied to respective different nodes, thereby obtaining the DOM content corresponding to the predetermined rendered style.

In a step S230, the DOM content corresponding to the predetermined rendered style is rendered in a window other than the main window. Accordingly, the DOM content corresponding to the predetermined rendered style can be displayed in the window.

According to an embodiment of the invention, if different scenario simulations are to be displayed in a plurality of windows, in the step S220, the DOM tree is modified correspondingly according to a plurality of different rendered styles. DOM trees corresponding to the plurality of different windows are generated and dispatched to the plurality of different windows respectively, thereby the DOM content is rendered in the plurality of different windows and the rendered DOM content is displayed therein. Those skilled in the art know that, there are different ways to display the windows. For example, the main window can be displayed simultaneously with and compared with other windows, or different windows can be respectively displayed through window switching during the operation, thereby respectively viewing different scenario simulations. As discussed above, the invention can provide respective CSS configurations according to different rendering scenarios to be tested. In testing the target rendering scenario, by traversing all the nodes in DOM by JavaScript, those CSS meeting rules can be applied to respective different nodes, and are then delivered to the browser to be re-rendered into a final display style required by the test.

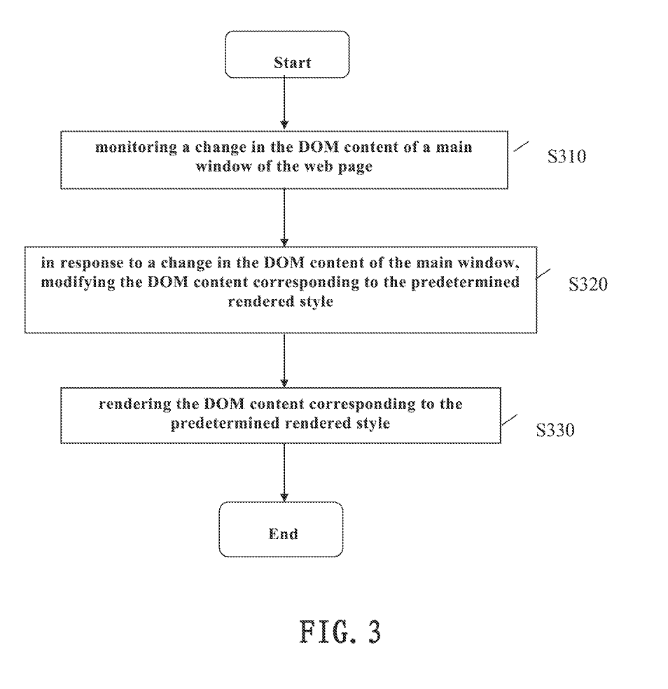

FIG. 3 shows a method of processing a web page according to another embodiment of the invention. According to the embodiment, when the DOM content of the main window is changed, display in a respective window will be synchronized correspondingly.

In a step S310, a change in the DOM content of a main window of the web page is monitored. According to an embodiment of the invention, the change in the DOM tree can be monitored by adding some event triggers provided by the browser when the browser loads the DOM tree. The interface that can be seen by the user is a result after the DOM tree is completely rendered by the browser. After finishing the rendering, if a user event triggers the event triggers, a method defined beforehand will be invoked so as to achieve a monitoring effect. Here, the change in the DOM tree can comprise a change in any node of the DOM tree. Therefore, once the DOM tree is changed by any means, which includes an attribute of a node is changed, a node is deleted, a node is added and the like, the change can be detected.

In a step S320, in response to the change in the DOM content of the main window, the DOM content corresponding to the predetermined rendered style is modified. According to an embodiment of the invention, after the changed DOM content of the main window is re-obtained, a new DOM content can be generated according to the predetermined rendered style and the changed DOM content of the main window. According to another embodiment of the invention, only those portions corresponding to the change in the DOM content of the main window can be modified on the basis of the current DOM content corresponding to the predetermined rendered style, so as to obtain the updated DOM content corresponding to the predetermined rendered style.

Then in a step S330, render the DOM content corresponding to the predetermined rendered style, such that the rendered DOM content corresponding to the predetermined rendered style can be displayed in the browser window.

In this way, each time the content of the DOM tree of the main operating window is changed, various other windows will also be re-rendered to maintain synchronized with the content of the main operating window. Thus, the user can view and detect the displayed contents in other modes by operating a main operating window only once.

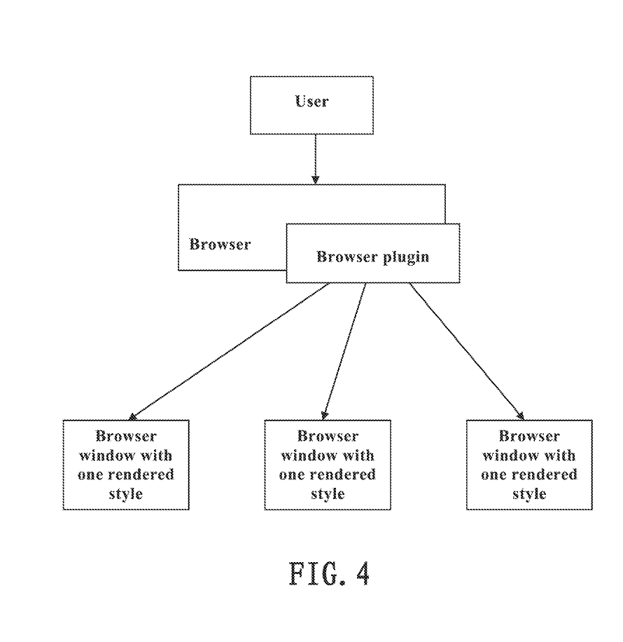

FIG. 4 is a schematic diagram showing a process of exhibiting different rendered styles of the web page with a plurality of rendering windows according to an embodiment of the invention. In the embodiment, the browser environment provides a plurality of windows corresponding to different rendered display modes, e.g., a display mode without CSS, various high contrast modes and etc. There is a main operating window among the plurality of windows, in which the user performs various operations. Other windows exhibit different rendered display modes of the web page by copying the DOM content of the main window, modifying the DOM content according to the different rendering styles corresponding to the different rendered display modes and performing re-rendering. Moreover, when the DOM tree of the main operating window is changed, the respective other windows will be also redrawn to maintain synchronized with the content of the main operating window. Here, a browser plugin can be used to monitor an event in the main operating window, and to manage dispatching and rendering of the DOM content to the respective other windows. It should be noted that, although the embodiment is described here in a form of a browser plugin, it is merely an exemplary embodiment. Those skilled in the art could adopt other embodiments. For example, the plugin can be consolidated into the browser as a function of the browser such that the browser is directly carried with the above function to implement the invention.

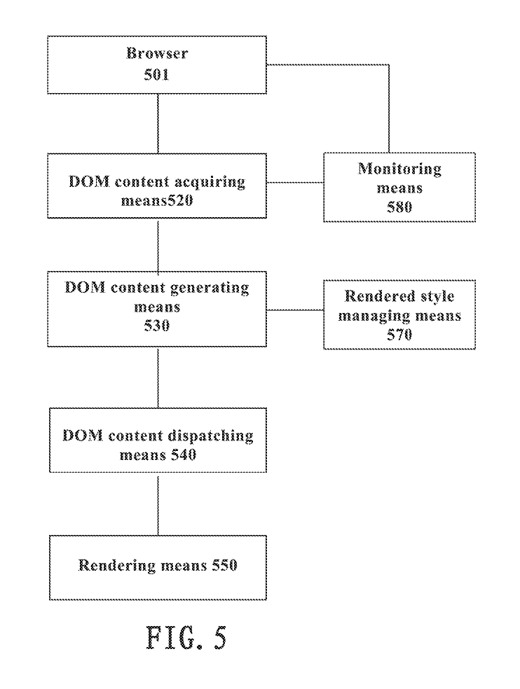

Next, a system for processing a web page according to an embodiment of the invention will be described with reference to FIG. 5. The system can include DOM content acquiring means 520, DOM content generating means 530, DOM content dispatching means 540 and rendering means 550. For the purpose of description, a browser 510 is also shown in FIG. 5, but the browser is not a part of the system of the invention.

The DOM content acquiring means 520 is configured to acquire a DOM content of a main window of the web page. As discussed above, acquiring the DOM content of the current page from a browser can be implemented by JavaScript from an API provided by the browser, or directly obtained from an API in some plugins of Firefox.

The DOM content generating means 530 is configured to generate, according to at least one predetermined rendered style and the DOM content of the main window, a DOM content corresponding to the at least one predetermined rendered style, wherein the rendered style may be preset, e.g., may include CSS styles with different configurations. According to different rendering scenarios to be tested, respective CSS configurations can be provided. In testing the target rendering scenario, by traversing all the nodes in the DOM by JavaScript, those CSS meeting rules can be applied to respective different nodes, thereby obtaining the DOM content corresponding to the predetermined rendered style.

The DOM content dispatching means 540 is configured to dispatch the generated DOM tree to respective windows.

The rendering means 550 is configured to render the DOM content corresponding to the at least one predetermined rendered style in at least one window other than the main window, such that the rendered DOM content is displayed in the at least one window.

If it different scenario simulations are to be displayed in a plurality of windows, the DOM content generating means 530 modifies the DOM tree correspondingly according to a plurality of different rendered styles, and the DOM content dispatching means 540 dispatches the modified plurality of DOM trees respectively to the plurality of different windows, so as to render the DOM content and display the rendered DOM content in the plurality of different windows.

According to an embodiment of the invention, the system further can include rendered style managing means 570 configured to manage available rendered styles and information on specific rendered modes of the respective styles. Those skilled in the art would appreciate that, the invention is not limited to the use of the rendered style managing means for providing the above information, and other means known to those skilled in the art could be also used to provide the rendered styles and information on the respective rendered styles.

According to an embodiment of the invention, operation setting of the invention, including relevant configuration information such as how many windows, which rendered styles are used respectively and the like, can be managed through configuration information managing means (not shown in the figures). The configuration information managing means allows the user to select a specific display scenarios and display setting thereof, e.g., color scheme and so on. Likewise, the invention is not limited to the use of the configuration information managing means for providing the above information, and other means known to those skilled in the art could be adopted to provide the relevant configuration information.

For example, if one wants to display a MS Windows high contrast mode, the DOM content acquiring means 520 transmits the acquired DOM tree to the DOM content generating means 530, and the DOM content generating means 530 adds relevant attributes to each node by using JavaScript, for example, the background image would be none. Then, the DOM content dispatching means 540 transmits the generated DOM tree to a popup window of the browser to render and display the HTML page. In this way, we will have a normal HTML page and a high contrast page with the same content.

According to an embodiment of the invention, the system further comprises monitoring means 580 configured to monitor a change in a DOM content of a main window of a web page. According to an embodiment of the invention, the change in the DOM tree can be monitored by adding some event triggers provided by the browser when the browser loads the DOM tree. The interface that can be seen by the user is a result after the DOM tree is completely rendered by the browser. After finishing the rendering, if a user event triggers the event triggers, a method defined beforehand will be invoked so as to achieve a monitoring effect. Here, the change in the DOM tree can comprise a change in any node of the DOM tree. Therefore, once the DOM tree is changed by any means, which includes an attribute of a node is changed, a node is deleted, a node is added and the like, the change can be detected.

In response to the change in the DOM content of the main window, the DOM content generating means 530 modifies the DOM content corresponding to the predetermined rendered style. Then the rendering means re-render the DOM content corresponding to the predetermined rendered style. Moreover, the rendered DOM content corresponding to the predetermined rendered style is displayed in the browser window.

In this way, each time the content of the DOM tree of the main operating window is changed, respective other windows will also be re-rendered to maintain synchronized with the content of the main operating window. Thus, the user can view and detect the displayed contents in other modes by operating a main operating window only once.

For example, in order that all the scenarios of a web page are synchronized with each other, when an initial DOM tree is acquired from the browser, the invention will use JavaScript to monitor various events, and when the DOM tree is changed, the changes can be captured. Any DOM tree node change, including attribute change, DOM node insertion, deletion and etc., will be detected. In the case where the change in the DOM tree of the main operating window is detected, the DOM content of the main operating window is re-obtained, and the DOM content of the main operating window is delivered to the DOM content generating means 540 to be modified and re-rendered by the rendering means.

In this way, the user can view display results in various different rendered styles without changing the local browser and the system configuration. Moreover, when it is needed to make comparison in different rendered display modes, the invention can make the user simultaneously compare various different rendered display modes in the same web page state. For example, when the user prepares to carry out a test of information accessibility for the web page, he can simultaneously carry out the test of information accessibility for the web page in the step of function test. When the user needs viewing and testing various different rendered styles of the web page, with the invention, the originally repeated operations become an operation needing to be performed only once, which can save a great deal of time and manpower consumption. Since the invention synchronizes the windows when the content of the DOM tree is changed, it can also desirably capture the content change caused by a mouse hover event. In other words, so long as the display of the main operating window is changed, the invention can synchronize the latest content to the sub-windows to exhibit the rendered contents in the various modes.

The embodiments of the invention perform synchronized rendering according to the DOM content so that each sub-window will not transmit and receive a network request, so as to guarantee complete synchronization of the contents. Therefore, the invention is a universal method, and can be applied to different web page applications, including web pages made by the latest web 2.0 technology (e.g. dojo), without the need of making specific settings for each project.

The invention utilizes HTML and browser plugin technologies, starts with the inputted Document Object Model (DOM) finally displayed in the web page, performs unified scenario simulation for each node appearing in the web page, and thus achieves simultaneous exhibition of a plurality of specific display modes. This facilitates detection of information integrity by the testers, can make comparison and verification between the plurality of specific display modes without switching and setting parameters of any system level, and thus improves efficiency and reduces error rate. Moreover, by listening to all node events in the inputted Document Object Model (DOM), functions in all specific display scenarios are made consistent with each other, such that by performing the function detection in a certain scenario only once, the testers can at the same time test and validate function tests in other simulated scenarios, thereby saving a lot of time.

Although the test of information accessibility for the web page is taken as an example here for describing the invention, those skilled in the art know that, the invention is not limited to the test of information accessibility for the web page, and the invention is adapted to any situation where a plurality of different display scenarios of the web page need to be simulated.

Furthermore, although embodiments for a system of the invention are described to include means such as DOM content acquiring means, DOM content generating means, DOM content dispatching means and rendering means, those skilled in the art know that, the above means can be implemented by either universal hardware means, or by computer software programs in which case the means may be understood as software function modules capable of implementing the embodiments of the invention.

The flowchart illustrations and block diagrams in the figures illustrate the architecture, functionality, and operation of possible implementations of systems, methods and computer program products according to various embodiments of the present invention. In this regard, each block in the flowchart illustrations or block diagrams may represent a module, program segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable those of ordinary skill in the art to understand that the invention comprises various embodiments with various modifications adapted to the particular desirable use.

What is claimed is:

1. A method of processing a web page, comprising:
acquiring a Document Object Model (DOM) content of a main window of the web page;
generating, according to at least one predetermined rendered style and the DOM content of the main window, a DOM content corresponding to the at least one predetermined rendered style; and
rendering the DOM content corresponding to the at least one predetermined rendered style in at least one window other than the main window using a processor.

2. The method according to claim 1, wherein acquiring a DOM content of a main window of the web page further comprises:
in response to a change in the web page displayed in the main window, acquiring the changed DOM content of the main window.

3. The method according to claim 2, wherein generating a DOM content corresponding to the at least one predetermined rendered style further comprises:
in response to a change in the DOM content of the main window, modifying the DOM content corresponding to the at least one predetermined rendered style.

4. The method according to claim 1, further comprising:
dispatching the DOM content corresponding to the at least one predetermined rendered style to the at least one window other than the main window.

5. The method according to claim 1, wherein the at least one predetermined rendered style corresponds to at least one specific display mode.

6. A system for rendering a web page, comprising:
DOM content acquiring means configured to acquire a Document Object Model (DOM) content of a main window of the web page;
DOM content generating means configured to generate, according to at least one predetermined rendered style and the DOM content of the main window, a DOM content corresponding to the at least one predetermined rendered style; and
rendering means configured to render the DOM content corresponding to the at least one predetermined rendered style in at least one window other than the main window.

7. The system according to claim 6, wherein in response to a change in the web page displayed in the main window, the DOM content acquiring means acquires the changed DOM content of the main window.

8. The system according to claim 7, further comprising:
DOM content monitoring means configured to monitor a change in the DOM content of the main window, wherein the DOM content generating means is further configured to, in response to a change in the DOM content of the main window, modify the DOM content corresponding to the at least one predetermined rendered style.

9. The system according to claim 6, further comprising:
DOM content dispatching means configured to dispatch the DOM content corresponding to the at least one predetermined rendered style to the at least one window other than the main window.

10. The system according to claim 6, wherein the at least one predetermined rendered style corresponds to at least one specific display mode.

11. A system for rendering a web page, comprising:
a processor configured to initiate executable operations comprising:
acquiring a Document Object Model (DOM) content of a main window of the web page;
generating, according to at least one predetermined rendered style and the DOM content of the main window, a DOM content corresponding to the at least one predetermined rendered style; and
rendering the DOM content corresponding to the at least one predetermined rendered style in at least one window other than the main window.

12. The system according to claim 11, wherein acquiring a DOM content of a main window of the web page further comprises:
in response to a change in the web page displayed in the main window, acquiring the changed DOM content of the main window.

13. The system according to claim 12, wherein generating a DOM content corresponding to the at least one predetermined rendered style further comprises:
in response to a change in the DOM content of the main window, modifying the DOM content corresponding to the at least one predetermined rendered style.

14. The system according to claim 11, further comprising:
dispatching the DOM content corresponding to the at least one predetermined rendered style to the at least one window other than the main window.

15. The system according to claim 11, wherein the at least one predetermined rendered style corresponds to at least one specific display mode.

16. A computer program product for processing a web page, the computer program product comprising:
a computer readable storage medium having stored thereon program code that, when executed, configures a processor to perform executable operations comprising:
acquiring a Document Object Model (DOM) content of a main window of the web page;
generating, according to at least one predetermined rendered style and the DOM content of the main window, a DOM content corresponding to the at least one predetermined rendered style; and
rendering the DOM content corresponding to the at least one predetermined rendered style in at least one window other than the main window.

17. The computer program product according to claim 16, wherein acquiring a DOM content of a main window of the web page further comprises:
in response to a change in the web page displayed in the main window, acquiring the changed DOM content of the main window.

18. The computer program product according to claim 17, wherein generating a DOM content corresponding to the at least one predetermined rendered style further comprises:
in response to a change in the DOM content of the main window, modifying the DOM content corresponding to the at least one predetermined rendered style.

19. The computer program product according to claim 16, further comprising:
dispatching the DOM content corresponding to the at least one predetermined rendered style to the at least one window other than the main window.

20. The computer program product according to claim 16, wherein the at least one predetermined rendered style corresponds to at least one specific display mode.
